(19) United States
(12) Patent Application Publication
(10) Pub. No.: US 2023/0153843 A1
(43) Pub. Date: May 18, 2023

(54) SYSTEM TO COMBINE INTELLIGENCE FROM MULTIPLE SOURCES THAT USE DISPARATE DATA SETS

(71) Applicant: Oracle International Corporation, Redwood Shores, CA (US)

(72) Inventors: Anupama Iyengar Singhvi, Ashburn, VA (US); Rutuja Joshi, Redwood City, CA (US); José R. Villacís, San Jose, CA (US); David Randolph Quick, Atlanta, GA (US); Nigel Baldwin, Berkshire (GB); Bertalan Danko, Seattle, WA (US); Jamie L. Bubier, Woodside, CA (US)

(73) Assignee: Oracle International Corporation, Redwood Shores, CA (US)

(21) Appl. No.: 17/525,542

(22) Filed: Nov. 12, 2021

(51) Int. Cl. G06Q 30/02; G06F 16/23; G06N 20/20

(52) U.S. Cl. CPC G06Q 30/0202; G06F 16/2365; G06N 20/20

(57) ABSTRACT

Example embodiments include software for selectively combining outputs for multiple machine learning modules, so as to generate composite values. The composite values may provide more accurate metrics, e.g., composite scores, that may be used to more reliably predict/estimate, for instance, the likelihood of a given lead converting into a customer within a predetermine time interval. In certain embodiments, a math model selectively combines the scores, and the parameters thereof can be selectively adjusted in real time, based on real time data; so as to maintain accuracy of the composite scores. This can lead to enhanced situational awareness, which can be particularly important for enterprise sales representatives, account managers, and so on.

### BACKGROUND

The present application relates to computing, and more specifically to software, systems and methods for facilitating informed decision making, e.g., helping sales personnel to select leads to pursue based on enhanced knowledge.

Systems and methods for facilitating informed decision making are employed in various demanding application, including enterprise software for tracking sales leads, medical-industry databases for tracking patients and associated conditions, market analysis software for facilitating placing accurate trades, and so on. Such applications often demand insightful tools for enhancing informed decision making based upon the insights.

Informed decision making can be particularly important for businesses implementing marketing programs, sales campaigns, and so on, where inefficiencies at pursuing proper marketing segments and individual potential customers may be particularly costly.

In an example scenario, only a small fraction of leads from marketing events or sales campaigns result in actual revenue. A sales representative may use several scores or metrics associated with a particular lead, so as to make decisions as to whether or not to pursue the lead. However the multiple metrics from various disparate sources can be confusing, and sales representatives may not know which leads to focus on.

### SUMMARY

Various embodiments discussed herein use multiple Artificial Intelligence (AI) engines (also called machine learning models herein) to analyze input data sets; then strategically select and combine results into a composite score, which may, for instance, indicate the likelihood that a given lead (e.g., potential customer or preexisting customer) will make a purchase of a product and/or service within a predetermined time interval. The composite score is then used to facilitate informed decision-making, e.g., by sales personnel, account managers, and so on. Note, however, that other embodiments are possible, and embodiments are not necessarily limited to use with marketing and/or sales operations, which may require accurate estimates as to whether or not a given lead is likely to make a purchase.

An example method facilitates estimating a propensity for a business lead to purchase a product or service from an organization, and includes: receiving output from two or more machine learning models, resulting in received output in response thereto, wherein the two or more machine learning models use different data sets to provide the output, and wherein the output includes plural scores, including one or more scores from each of the two or more machine learning models; and selectively combining the plural scores to provide a composite score via a combining method.

In a more specific embodiment, the combining method further includes selectively weighting and adding estimates using one or more weighted probability distributions. The combining method may further involve use of a Monte Carlo method.

In a more specific embodiment, the example method further includes monitoring the composite score for accuracy to determine when the composite score becomes less accurate relative to its accuracy based on historical data; and then selectively adjusting the combining method so as to maintain or improve the accuracy of the composite score.

The example method may further include providing the composite score to an analytics User Interface (UI), thereby facilitating informed decision making of a user of the UI.

Each machine learning model may receive plural database inputs describing or characterizing a business lead. The database inputs may include, for instance, one or more of the following: website views associated with the lead, measurements of website click-through behaviors, data from email responses pertaining to the product or service, data with chats from sales representatives, and measurements of engagement at one or more events.

Each machine learning model may employ an artificial intelligence algorithm implemented via one or more trained neural networks, so as to output the one or more scores.

Accordingly, certain embodiments discussed herein may facilitate ascertaining the likelihood of a given lead to purchase a product and/or service within a predetermined time interval. A math model employs adjustable parameters, which may be adjusted to account for any substantial divergences in predictive performance.

Lead scores from a marketing automation system may be leveraged by embodiments discussed herein to create a composite score, which can be used to classify leads; such that business users (e.g., sales and/or marketing personnel) can more readily understand a given lead's propensity to make a purchase of a product or service within a predetermined time interval.

Accordingly, multiple AI engines can be used by embodiments discussed herein to access disparate data sets, to analyze those data sets; then an additional module may select a set of top results, which may then be used to create a composite score characterizing a given lead. The composite score can then be used to facilitate more informed decision making by business personnel, e.g., sales representatives, account managers, and so on.

Certain embodiments herein may provide a source of insight that offers a broad view of descriptors a given sales lead. This may substantially increase lead-conversation rates and efficiencies associated with converting those leads into sales.

A further understanding of the nature and the advantages of particular embodiments disclosed herein may be realized by reference of the remaining portions of the specification and the attached drawings.

### BRIEF DESCRIPTION OF THE DRAWINGS

FIG. 1 illustrates a first example system and accompanying computing environment for facilitating combining data from multiple sources to generate an optimized composite score for use in an analytics User Interface (UI) along with other data derived from the multiple sources.

FIG. 2 illustrates a second example system and accompanying computing environment, which leverages preexisting computing resources from a marketing automation system to harvest lead scores and data used to generate a composite score via use of a math model.

FIG. 3 is a flow diagram of a first example method for creating a composite score using the math models of FIG. 1 and/or FIG. 2.

FIG. 4 is a flow diagram of a second example method for facilitating forecasting lead conversion propensity based on outputs from multiple machine learning models.

FIG. 5 is a flow diagram of a third example method for calculating a composite score based on scores output from two or more machine learning models.

FIG. 6 is a flow diagram of a fourth example method, which represents a general method suitable for use with the embodiments of FIGS. 1-5.

FIG. 7 is a flow diagram of a fifth example method, which graphically depicts calculation of a composite score based on one or more scores from one or more machine learning models.

FIG. 8 illustrates a block diagram of an example network environment, which may be used for implementations described herein.

FIG. 9 illustrates a block diagram of an example computing device or system, which may be used for implementations described herein.

### DETAILED DESCRIPTION OF EMBODIMENTS

For the purposes of the present discussion, a computing environment may be any collection of computing resources used to perform one or more tasks involving computer processing. A computer may be any processor in communication with a memory. Generally, computing resource may be any component, mechanism, or capability or quantities thereof of a computing environment, including, but not limited to, processors, memories, software applications, user input devices, and output devices, servers, processes, and so on.

An enterprise computing environment may be any computing environment used for an enterprise. An enterprise may be any organization of persons, such as a business, university, government, military, and so on. The terms “organization” and “enterprise” are employed interchangeably herein.

An example enterprise computing environment includes various computing resources distributed across a network and may further include private and shared content on intranet web servers, databases, files on local hard discs or file servers, email systems, document management systems, portals, and so on. The terms “computing system” and “computing environment” may be used interchangeably herein.

For the purposes of the present discussion, a server may be any computing resource, such as a computer and/or software that is adapted to provide content, e.g., data and/or functionality, to another computing resource or entity that requests it, i.e., the client. A client may be any computer or system that is adapted to receive content from another computer or system, called a server. A Service Oriented Architecture (SOA) server may be any server that is adapted to facilitate providing services accessible to one or more client computers coupled to a network.

A networked computing environment may be any computing environment that includes intercommunicating computers, i.e., a computer network. Similarly, a networked software application may be computer code that is adapted to facilitate communicating with or otherwise using one or more computing resources, e.g., servers, via a network.

A networked software application may be any software application or computer code adapted to use data and/or functionality provided via one or more resources, e.g., data, memory, software functionality, etc., accessible to the software application via a network.

A software system may be any collection of computing resources implementing machine-readable instructions, i.e., computer code. Accordingly, the term “software system” may refer to a software application, and depending upon the context in which the term is used, may further refer to the accompanying computer(s) and associated computing resources used to run the software application.

Depending upon the context in which the term is used, a software system may further include hardware, firmware, and other computing resources enabling running of the software application. Note that certain software systems may include collections of disparate services, which are implemented in particular sequences in accordance with a process template and accompanying logic. Accordingly, the terms “software system,” “system,” and “software application” may be employed interchangeably herein to refer to modules or groups of modules or computing resources used for computer processing.

For clarity, certain well-known components, such as hard drives, processors, operating systems, power supplies, Internet Service Providers (ISPs), Application Programming Interfaces (APIs), web services, websites, and so on, are not necessarily explicitly called out in the figures. However, those skilled in the art with access to the present teachings will know which components to implement and how to implement them to meet the needs of a given implementation.

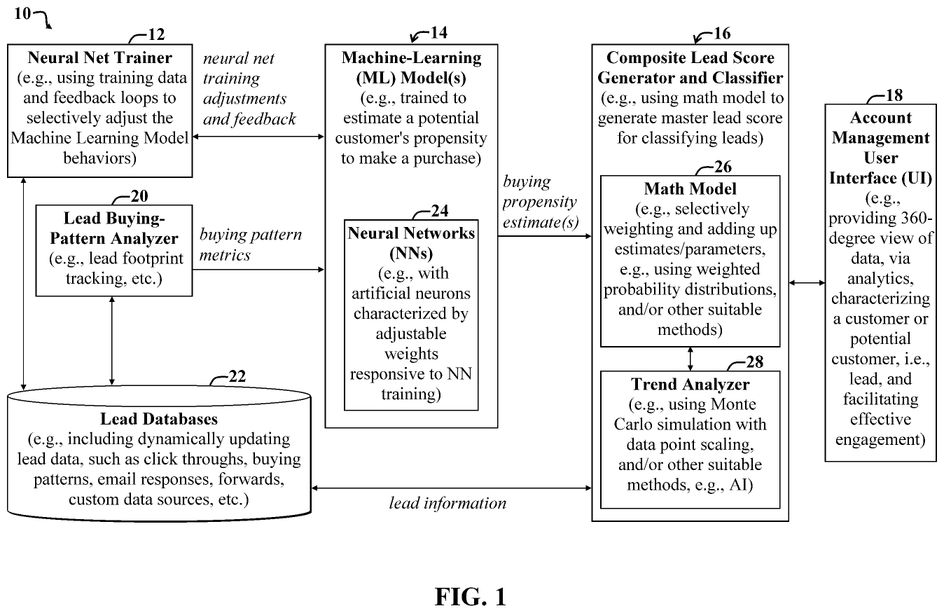

FIG. 1 illustrates a first example system 10 and accompanying computing environment for facilitating combining data from multiple sources (e.g., represented by lead databases 22) to generate an optimized composite score for use in an analytics User Interface (UI) along with other data derived from the multiple sources.

The composite score is then usable via analytics software, which is represented by an account management UI 18 used to display analytics, e.g., via visual coding, via one or more UI display screens. The analytics may include graphs or plots of historical composite scores versus lead conversion rates, visually displayed data, in addition to composite scores pertaining to one or more leads, and so on.

For the purposes of the present discussion, an analytic may be any calculation or measurement based on a given input. Certain analytics may be displayed graphically. In general, a graphically displayed analytic or other visual representation of data is called a visualization herein.

Visual coding may be any mechanism for visually distinguishing a user interface feature to provide context information to the user. The context information may include, for example, information indicating that a particular lead is estimated to more likely to make a purchase of a product or service or to join a particular organization. A lead may be any potential customer or preexisting customer of an organization or enterprise (also called business herein).

For the purposes of the present discussion, the terms enterprise and business are taken to include any organization of persons, including universities, governments, militaries, governmental departments, companies, and so on.

The account manager UI 18 may display visualizations that offer both high level and detailed views (e.g., a 360-degree view) of data describing one or more leads, thereby providing substantial insight for account managers to effectively and efficiently engage with leads.

The present example system 10 includes a neural net trainer 12 in communication with one or more Machine Learning (ML) models 14 and one or more of the lead databases 22. For the purposes of the present discussion, a machine learning model may be any computer software program or algorithm that can be trained (e.g., via supervised learning) or self-trained (e.g., via unsupervised learning), such that it can make improvements responsive to mistakes, e.g., as indicated by error signals, cost functions, or other means of gauging divergence of outputs from preferred outputs.

The example machine learning models 14 incorporate neural networks 24, which exhibit internal weights that can be adjusted via one or more feedback loops implemented, in part, by the neural net trainer 12. This may include, for instance, comparing output from the neural networks 24 responsive to input data; generating an error signal in response thereto; then adjusting weights of artificial neurons included in the neural networks 24, so as to selectively reduce or minimize the error signal, without over training the neural nets 24.

Note that in general, groupings of various modules of the system 10 are illustrative and may vary, e.g., certain modules may be combined with other modules or implemented inside of other modules, or the modules may otherwise be distributed differently (than shown) among a network or within one or more computing devices or virtual machines, without departing from the scope of the present teachings. For example, the neural net trainer 12 may be incorporated within the machine learning models 14. Similarly, a trend analyzer 28 of a composite lead score generator and classifier 16 may be shown included within the math model 26, without departing from the scope of the present teachings. Furthermore, math model 26 may be implemented separately from the composite lead score generator and classifier 16, which in certain embodiments may be implemented by the machine learning models 14.

The neural net trainer 12 may obtain sample data (aka training data) from the lead databases 22 for use in training the machine learning models 14 and accompanying neural networks 24.

A lead buying pattern analyzer 20, which may also employ its own machine learning models, includes software for analyzing data in the lead databases 22 and producing buying pattern metrics for different leads in the database 22. These buying pattern metrics may provide input to the machine learning models 14 to facilitate generation of outputs by the machine learning models 14.

The buying pattern analyzer 20 may also store historical buying pattern metrics in the lead databases 22, which can be used by the neural net trainer 12 as part of a training data set for use in training the machine learning models 14.

The machine learning models 14, once initially trained, can use the buying pattern metrics characterizing leads (e.g., customers, potential customers, etc.) to generate buying propensity estimates, also called scores herein. A score may represent a type of metric characterizing a particular lead. For the purposes of the present discussion, a metric may be any value, e.g., number, or other data or descriptor, associated with a thing or process. Note that in some embodiments, the machine learning models 14 may communicate directly with the lead databases 22.

In embodiments where more than one machine learning model 14 is employed, each machine learning model 14 may use its own disparate database(s) from among the lead databases 22 to derive its scores.

Examples of lead data that may be stored in the lead databases 22 include business intelligence, such as digital body language of a lead (e.g., their searches, web clicks, job postings, etc.), their competitive technology foot print, etc. from external data sources with internal machine learning models that may estimate a lead's propensity to buy, their footprints at a given enterprise (e.g., applicable to their buying patterns from that enterprise), metrics measuring their engagement at various events, their web clicks, software or white paper downloads, chats with sales representatives, and so on.

Note that characterizations of their responses to emails from topic specific e-blasts (views, click-throughs, forwards, etc.) can significantly impact engagement and increase lead-to-opportunity and opportunity-to-revenue conversion rates. Furthermore, in certain embodiments, the characterizations and associated metrics may be obtained via use of artificial intelligence algorithms to process the emails, etc., and to generate the metrics, etc., in response thereto.

Scores output by the machine learning models 14 are input to the composite lead score generator and classifier 16. In the present example embodiment, the composite lead score generator and classifier 16 uses a math model 26 in communication with a trend analyzer 28, to provide composite scores to the account management UI 18.

The math model 26 includes software for selectively weighting and adding up estimates/parameters using one or more mathematical methods, such as probability distributions, selectively weighted and/or normalized linear combinations of scores, etc., to generate composite scores for use by the account management UI 18.

In the present example embodiment, a trend analyzer 28 analyzes performance of the composite scores (and accurately indicating buying propensity or likelihood for a given lead to result in a purchase of a product or service within a predetermined time interval) with respect to real time data that is being populated into the lead databases 22. The trend analyzer 28 can observe when the composite scores output by the math model 26 diverge in accuracy; then can issue strategic adjustments to parameters (e.g., scaling factors for different values used in the math model 26), so as to reduce any observed divergences in accuracy.

Note that in certain embodiments, the math model 26 and trend analyzer 28 may be replaced by a machine learning model and accompanying neural network, without departing from the scope of the present teachings.

Accordingly, in the present example embodiment, the composite lead score generator and classifier 16 selectively combines buying propensity estimates or scores output the machine learning models 14, each of the scores of which may be derived using disparate data sets pertaining to a particular lead.

Note that a given machine learning model 14 of the machine learning models may produce plural scores for a given lead. Each of those scores may use different data sets. Similarly, different machine learning models may also use different data sets than those used by another machine learning model, so as to produce scores characterizing a given lead, e.g., characterizing or estimating their likelihood of following through on a purchase of a produce and/or service from a business, within a predetermined time interval.

Accordingly, the system 10 is adapted to generate a master lead score (also called, composite score), which may represent a selectively weighted probability distribution, and may also include Monte Carlo simulations for analyzing trends by strategically scaling the number of data points. This enables an account manager or sales representative to leverage, e.g., via the account manager UI 18, the composite score, in combination with other data pertaining to a particular lead (the other data of which may be retrieved by the account manager UI 18 from the lead databases 22 via the composite lead score generator and classifier 16).

Note that while, in the present example embodiment, the account management UI 18 is not shown directly communicating with the lead databases 22, that the account manager UI 18 may directly communicate with the lead databases 22, without departing from the scope of the present teachings.

Note that the account manager UI 18 may provide user access to various UI display screens for displaying different types of analytics, data visualizations, tools for drilling down into data underlying the visualizations, and so on.

For the purposes of the present discussion, a UI display screen may be any software-generated depiction presented on a display. Examples of depictions include windows, dialog boxes, displayed tables, data visualizations, and any other graphical user interface features, such as user interface controls, presented to a user via software, such as a browser. A user interface display screen contained within a single border is called a view or window. Views or windows may include sections, such as sub-views or sub-windows, dialog boxes, graphs, tables, and so on. In certain cases, a user interface display screen may refer to all application windows presently displayed on a display.

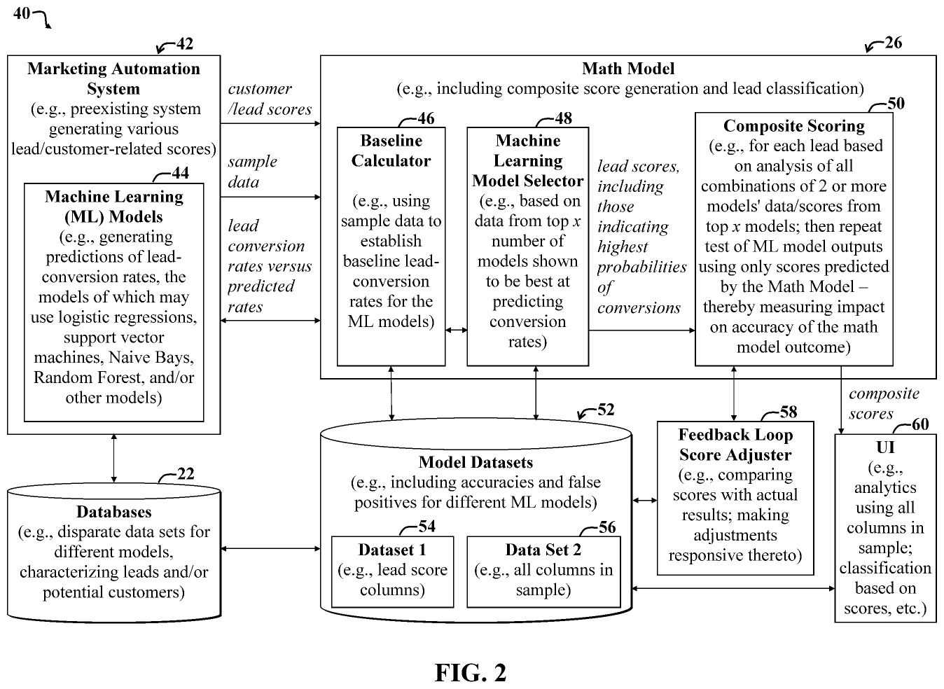

FIG. 2 illustrates a second example system 40 and accompanying computing environment, which leverages preexisting computing resources from a marketing automation system 42 to harvest lead scores and data used to generate a composite score via use of a math model 26.

In the present example embodiment, the marketing and automation system 42 represents a preexisting system that provides various software functionality, including that provided by machine learning models 44, which can be leveraged, e.g., via Application Programming Interfaces(s), to implement certain tasks.

For the purposes of the present discussion, software functionality may be any function, capability, or feature, e.g., stored or arranged data, that is provided via computer code, i.e., software. Generally, software functionality may be accessible via use of a user interface and accompanying user interface controls and features, and/or via an intermediary, e.g., an Application Programming Interface (API) and/or web service. Software functionality may include actions, such as retrieving data pertaining to a computing object (e.g., business object); performing an enterprise-related task, such as promoting, hiring, and firing enterprise personnel, placing orders, calculating analytics, launching certain dialog boxes, performing searches, and so on.

The example marketing automation system 42 includes several machine learning models, including models usable to generate predictions (e.g., via scores) of lead-conversion rates associated with different leads. The models 44, which may be independently selected and used, may include, for example, machine learning models that implement logistic regression algorithms, support vector machines, Naive Bays algorithms, Random Forest algorithms, and/or other algorithms.

The math model 26 communicates with the machine learning models 44 of the marketing and automation system 42. The math model 26 may receive machine learning model outputs, such as lead scores, sample data, metrics measuring lead conversion rates versus predicted (by the lead scores) lead conversion rates (e.g., error signals), and so on.

The marketing an automation system 42 and accompanying machine learning models 44 have access to databases 22, which may include a collection of disparate (i.e., separate or independent) data sets, which are used by different machine learning models, but which may be used to characterize leads, e.g., potential customers or preexisting customers or members.

In the present example embodiment, the math model 26 includes a baseline calculator 46. The baseline calculator 46 includes code for using sample data from the marketing and automation system 42 to establish baseline lead-conversion rates for each of the different machine learning models 44. The data, e.g., metrics indicating baseline lead-conversion rates for different leads and associated scores for each model, are then input into a machine-learning model selector 48.

The machine-learning model selector 48 employs data output from the baseline calculator 46 to select one or more models (and in a preferred embodiment, to select two or more models) from among the machine learning models 44 for use in a composite scoring process. The selected machine learning models from among the machine learning models 44 represent a selection from among the machine learning models that are estimated to be the most accurate at predicting lead-conversion rates, in accordance with output from the baseline calculator 46.

Outputs of the machine learning models selected (by the machine learning model selector 48) from among the machine learning models 44 are then provided as lead scores to a composite scoring module 50 of the math model 26. The selected lead scores from the selected machine learning models (from among the machine learning models 44) will be those indicating the highest probability of conversion of a lead within a predetermined time interval.

In the present example embodiment, the composite scoring module 50 implements a composite scoring algorithm that analyzes combinations of two or more models' data/scores from the top (selected) machine learning models; then repeats the test of machine-learning model outputs using only scores predicted by a composite score generated by the composite scoring module 50; thereby measuring impact on accuracy of the composite score. The measurement of impact may then be used, e.g., by a feedback loop score adjuster 58, to selectively adjust parameters of a composite scoring math model. Examples of math models that may be used by the composite scoring module 50 to compute a composite score are discussed more fully below.

The example feedback loop score adjuster 58 communicates with the composite scoring module 50 and a database of model data sets 52. Note that the feedback loop score adjuster 58 may be included within the composite scoring algorithm 50, without departing from the scope of the present teachings. Similarly, the model datasets database 52 may be included among the databases 22, without departing from the scope of the present teachings.

The feedback loop score adjuster 58 includes code for selectively adjusting parameters used by the composite scoring model 50 when selectively combining lead scores obtained via a selected group of two or more machine learning models 44 from among the machine learning models 44.

The example model datasets database 52 shows, for illustrative purposes, a first data set 54 and a second data set 56. The first data set 54 includes lead score columns, i.e., a collection of lead scores output by different machine learning models 44. The second data set 56 includes all columns in a given sample, i.e., all additional data; not just lead scores. Data from the first data set 54 and the second data set 56 are used by UI software 60 to facilitate providing a 360-degree view of data pertaining to a given lead, including composite scores associated with a lead's propensity to buy, i.e., become a customer or recurring customer.

Note that while the embodiments of FIGS. 1 and 2 are discussed with respect to use in maximizing situational awareness of marketing and/or sales representatives as it pertains to leads, embodiments are not limited thereto.

For instance, alternative embodiments may be employed in healthcare applications. For instance, embodiments may be used to aggregate patient data; generate projections of health status, and so on. Artificial intelligence may be employed to process patient history, treatment data, genetic data, and so on. Such a system may employ dynamically updating databases. The artificial intelligence algorithms may include functionality for suggesting treatment recommendations for given patients; offloading work to nurses, and so on. The software may also provide links to enable patients to sign up for clinical trials, and so on.

Accordingly, in healthcare implementations, certain embodiments may leverage an aggregate autonomously populating database (that may include genetic data and biometric keyed video-derived content) behind one or more artificial intelligence engines, for generating health predictions, treatment recommendations, etc. Such embodiments may implement a healthcare sensor net that feeds an aggregate database, where artificial intelligence interfaces the database with a feature rich analytics dashboard.

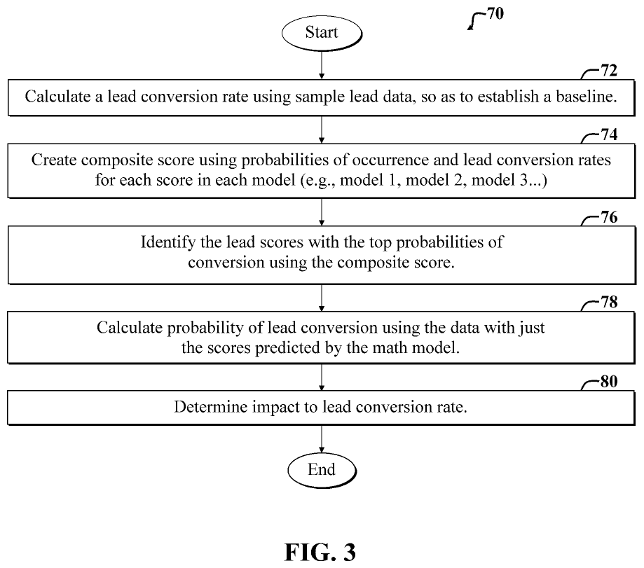

FIG. 3 is a flow diagram of a first example method 70 for creating a composite score using the math models 26 of FIG. 1 and/or FIG. 2.

The first example method 70 includes an initial lead-conversion rate calculating step 72 includes calculating a lead conversion rate, e.g., for each score, using sample data (also called historical data herein), so as to establish baseline lead conversion rates in association with different scores output by one or more machine learning models, e.g., the machine learning models 14 of FIGS. 1 and 2.

Next, a composite-score creating step 74 includes calculating a composite score using probabilities of occurrence and lead conversion rates for each score output by each machine learning model of the machine learning models 14 of FIGS. 1 and 2.

Subsequently, a lead-score identification step 76 includes identifying and selecting a batch of lead scores from a set of highest lead scores in a given sample of lead scores. For example, a top predetermined number of lead scores, including the highest lead score may be selected for further processing. The exact number of top lead scores selected for a given implementation may vary in accordance with the needs of a given implementation, with departing from the scope of the present teachings.

Next, a lead-conversion probability calculating step 78 includes calculating a probability of lead conversion for each selected lead score, as predicted by the math model 26 in FIGS. 1 and 2 and in step 76.

Subsequently, an impact-determining step 80 involves determining each lead-conversion probability value's impact on actual lead conversion rate; then selectively scaling the lead-conversion probability value accordingly when combining it into a composite score.

Example embodiments include software for selectively combining outputs for multiple machine learning modules, so as to generate composite values. The composite values may provide more accurate metrics, e.g., composite scores, that may be used to more reliably predict/estimate, for instance, the likelihood of a given lead converting into a customer within a predetermine time interval. In certain embodiments, a math model selectively combines the scores, and the parameters thereof can be selectively adjusted in real time, based on real time data; so as to maintain accuracy of the composite scores. This can lead to enhanced situational awareness, which can be particularly important for enterprise sales representatives, account managers, and so on.

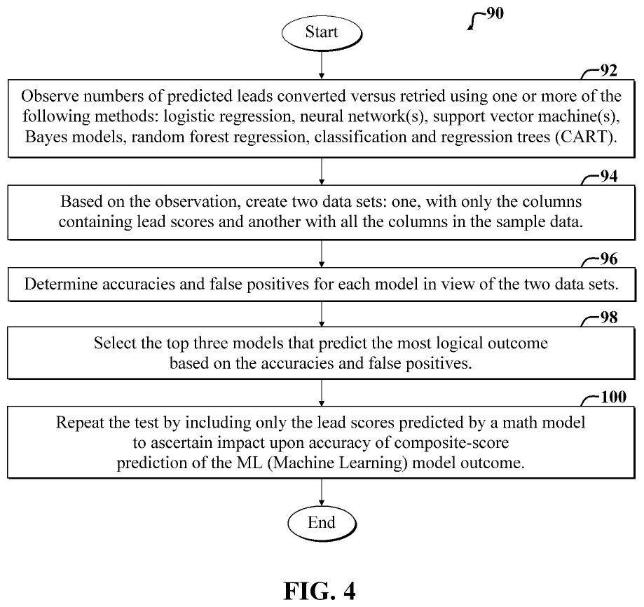

FIG. 4 is a flow diagram of a second example method 90 for facilitating forecasting lead conversion propensity based on outputs from multiple machine learning models.

An initial observation step 92 includes observing numbers of predicted leads for a given score versus retired leads for the score using two or more machine learning models. Example machine learning models include logistic regression, neural network, support vector machines, Bayes (e.g., Naive Bayes), random forest regression, and classification and regression trees. Such example machine learning models may be available via the marketing automation system 42 of FIG. 2, and outputs thereof may be selected from among the outputs of the machine learning models 44 of FIG. 2.

Next, a data-set creation step 94 includes creating two different data sets. In the present example embodiment, a first data set (e.g., corresponding to the first data set 54 of FIG. 2) includes columns of data that contain lead scores. Lead scores in these columns may include or represent composite lead scores and/or may include or represent lead scores output by the machine learning models 44 of FIG. 2.

A second data set (e.g., corresponding to the second data set 56 of FIG. 2) that includes all columns in a given sample. The sample may include all additional information extracted from the databases 22 for a particular lead. This may include, for instance, metrics describing a lead's engagement in related online forums (to the product or service to be sold to the lead), machine analysis and scoring of email exchange content between the lead and any sales representative or other marketing personnel, and other online “body language” characterizing applicable behaviors and/or preferences of a lead as it relates to product, service, and/or membership being offered to the lead.

Next, an accuracy-determining step 96 includes determining accuracies and false positives for each machine learning model output score in view of the two data steps determined in the data-set creation step 94.

Subsequently, based upon the accuracies and false positives determined in the accuracy-determining step 96, a selecting step 98 includes selecting the top three machine learning models that show the best performance, i.e., that most accurately predict the most logical outcomes, i.e., the most accurate outcomes. For the purposes of the present discussion, a more accurate outcome refers to a lead score that better predicts a lead conversion than another lead score in view of historical data.

Next, a repeating step 100 includes repeating steps 92-98 using only the lead scores predicted by the math model (e.g., the math model 26 of FIG. 2), e.g., using the composite score; so as to ascertain impact upon accuracy of the composite score prediction of each machine learning model score.

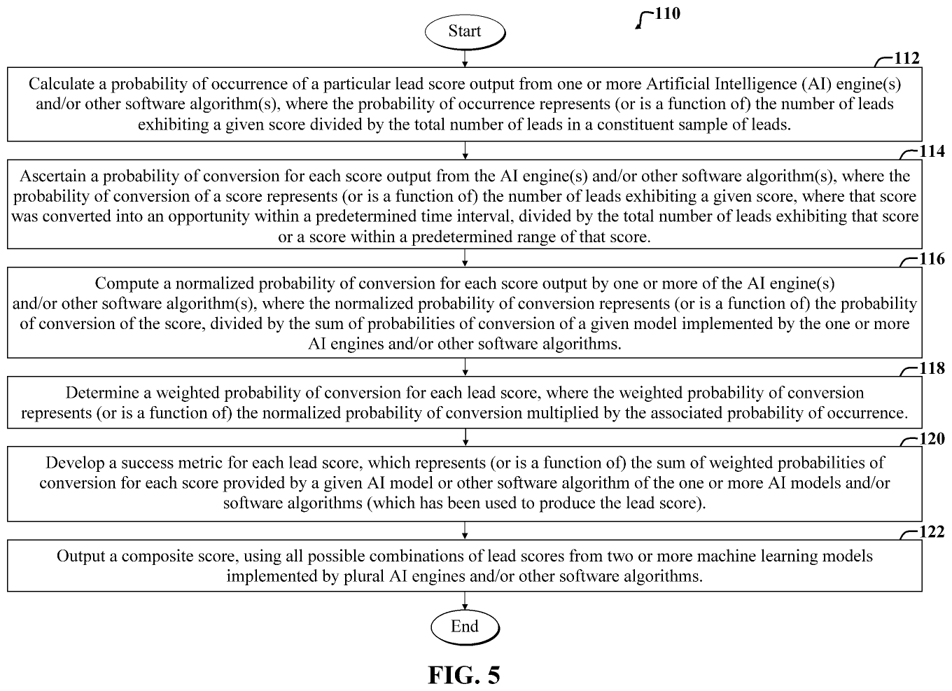

FIG. 5 is a flow diagram of a third example method 110 for calculating a composite score based on scores output from two or more machine learning models, e.g., the machine learning models 44 of FIG. 2. The method 110 may be implemented by the composite scoring module 50 of the math model 26 of FIG. 2.

An initial probability-of-occurrence (Poc) calculating step 112 includes calculating a probability of occurrence of a particular lead score output from one or more machine learning models, e.g., Artificial Intelligence (AI) engine(s), and/or other software algorithm(s), where the probability of occurrence represents (or is a function of) the number of leads (L) exhibiting a given score divided by the total number of leads in a constituent sample of leads (L_{Total}).

Accordingly:

Poc=L/L_{Total}. [1]

Next, a probability-of-conversion (Pconv) step 114 includes ascertaining/calculating a probability of conversion for each score output from the machine learning models (e.g., the models 44 of FIG. 2), e.g., AI engines and/or other software algorithms, where the probability of conversion of a score represents (or is a function of) the number of leads exhibiting a given score, where that score (Lconverted) was converted into an opportunity within a predetermined time interval, divided by the total number of leads exhibiting that score (L) or exhibiting a score within a predetermined range of that score.

Accordingly:

Pconv=Lconverted/L [2]

Subsequently, a normalized-probability-of-conversion (Npconv) calculating step 116 includes computing a normalized probability of conversion for each score output by one or more of the math models (e.g., AI engine(s) and/or other software algorithm(s)). The normalized probability of conversion represents (or is a function of) the probability of conversion of the score (Pconv) divided by the sum of probabilities of conversion (Sum(Pconv)) of a given model implemented by the one or more AI engines and/or other software algorithms.

Hence:

Npconv=(Pconv)/(Sum(Pconv)) [3]

Next, a weighted-probability-of-conversion step 118 includes determining a weighted probability of conversion (Pconv, weighted) for each lead score, where the weighted probability of conversion represents (or is a function of) the normalized probability of conversion (Npconv) multiplied by the associated probability of occurrence (Poc).

Accordingly:

Pconv,weighted=Npconv*Poc [4]

Subsequently, a success-metric-calculation step 120 includes developing a success metric (S) for each lead score, which represents (or is a function of) the sum of weighted probabilities of conversion (Sum (Pconv, weighted)) for each score provided by a given machine learning model (that has been used to produce the lead score).

Hence:

S=Sum(Pconv,weighted) [5]

Finally, a composite score step 122 includes outputting a composite score, using all possible combinations of lead scores from two or more machine learning models.

The composite score (Sc) may be calculated by multiplying the normalized probability of a first score in a first model (Npconv, 1, 1) by the probability of occurrence of the first score in the first model (Poc, 1, 1), plus the normalized probability of the first score in the first model (Npconv, 1, 1) multiplied by the probability of occurrence of the first score in the scone model ((Poc, 1, 2), and so on—adding up all normalized probabilities of occurrence of score N in model N; then dividing the sum by the sum of success metrics (Sum(S)) for all models used (e.g., models 1 through N).

For the purposes of the present discussion, the sum of the products between the normalized probabilities of the different models and the probabilities of occurrence of the scores in the different models is called a linear combination of normalized probabilities with probabilities of occurrences of scores in the different models.

Accordingly:

Sc=[(Npconv,1, 1)*Poc,1, 1)+(Npconv, 1, 1)*Poc, 1, 2)+. . . (Npconv,N,N)*Poc,N,N)]/Sum(S) [6]

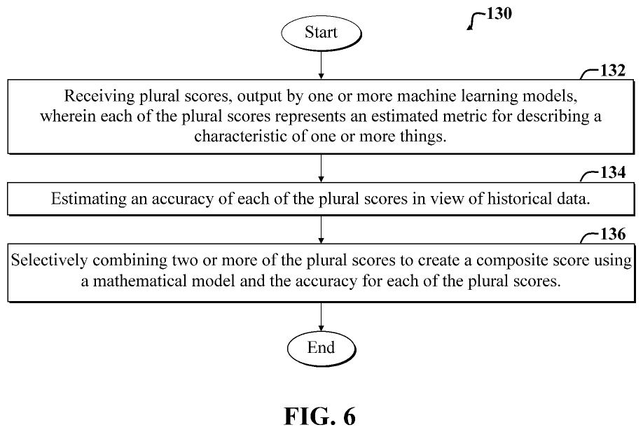

FIG. 6 is a flow diagram of a fourth example method 130, which represents a general method suitable for use with the embodiments of FIGS. 1-5. The fourth example method 130 facilitates estimating a propensity for a business lead to purchase a product or service from an organization, such as a business.

A first step 132, includes receiving plural scores, output by one or more machine learning models (e.g., the machine learning models 14 of FIG. 1 and/or machine learning models 44 of FIG. 2), wherein each of the plural scores represents an estimated metric for describing a characteristic of one or more things, such as a likelihood or propensity of a lead to make a purchase of a product or service and/or to join an organization.

A second step 134 includes estimating an accuracy of each of the plural scores in view of historical data. This may include, for instance, use of the trend analyzer 28 of FIG. 1 to access the lead databases 22 and compare accuracies of lead scores output by the machine learning models 14 with historical performance of the past lead scores.

A third step 136 includes selectively combining two or more of the plural scores to create a composite score using a mathematical model n (e.g., the math model 26 of FIG. 1) and the accuracy for each of the plural scores. For instance, a predetermined number of the top scores, i.e., most accurate scores given historical data, may be chosen for combination, e.g., via normalized linear combination, such as described in equation (6) above.

Note that the fourth example method 130 may be modified, without departing from the scope of the present teachings. For example, the fourth example method 130 may further specify that the characteristic includes a measurement of a likelihood that a potential customer or existing customer will purchase a product or service from a given business or join a given organization.

The third step 136 may further include: determining a probability of occurrence of each score for each of the one or more machine learning models, wherein the one or more machine learning models includes two or more machine learning models; calculating a probability of conversion of each score for each of the one or more machine learning models; ascertaining a normalized probability of occurrence for each probability of occurrence; and using a linear combination of the normalize probability of occurrence and the probability of conversion for each score of the two or more models to facilitate calculating the composite score.

The third step 136 may further include calculating a weighted probability of occurrence for each score for each of the two or more machine learning models based on the normalized probability of occurrence and the probability of occurrence for each score of the two or more models; computing a success metric based on adding together each weighted probability of occurrence for each score, resulting in a sum of weighted probabilities of occurrences; and adding together each success metric for each score, resulting in a sum of success metrics.

The third step 136 may further include selectively combining further include dividing the linear combination by the sum of success metrics, thereby yielding a composite score. The composite score may represent the measurement of a likelihood that a potential customer or existing customer will purchase a product or service from a given business or join a given organization. The composite score may then be employed to rank one or more customers or potential customers, thereby facilitating informed decision making by the given business or the given organization.

An alternative method for facilitating estimating a propensity for a business lead to purchase a product or service from an organization includes receiving output from two or more machine learning models, resulting in received output in response thereto, wherein the two or more machine learning models use different data sets to provide the output, wherein the output includes plural scores, including one or more scores from each of the two or more machine learning models; and selectively combining the plural scores to provide a composite score via a combining method.

The alternative method may further include selectively weighting and adding estimates using one or more weighted probability distributions. The alternative *method may further include includes use of a Monty Carlo method.

The alternative method may further include monitoring the composite score for accuracy to determine when the composite score becomes less accurate relative to its accuracy based on historical data; and then selectively adjusting the combining method so as to maintain or improve the accuracy of the composite score.

The composite score may be provided to an analytics UI (e.g., the UI 18 of FIG. 1 and/or the UI 60 of FIG. 2) thereby facilitating informed decision making of a user of the UI. Each machine learning model may receive plural database inputs describing or characterizing a business lead.

The database inputs may include, for instance, one or more of the following: website views associated with the lead, measurements of website click-through behaviors, data from email responses pertaining to the product or service, data with chats from sales representatives, and measurements of engagement at one or more events.

Each machine learning model may employ an artificial intelligence algorithm implemented via one or more trained neural networks so as to output the one or more scores.

Accordingly, certain embodiments discussed herein may compare predicted leads to actual conversions and lack of conversions, whereby math model parameters may be adjusted in response thereto, so as to account for any substantial error.

Acores output from machine learning models of a marketing automation system (e.g., the automation system 42 of FIG. 2) can be combined into a composite score, thereby enabling a new classification mechanism for leads. This enables users (e.g., sales and/or marketing representatives) to gain further insight into leads and their likelihoods of converting into sales.

Accordingly, certain embodiments may use multiple AI engines to access and analyze disparate data sets; then to the best results (e.g., top 2) to create a composite score. The composite score may then facilitate informed decision making, e.g., of sales and marketing personnel.

The UIs discussed herein (e.g., the UIs 18, 60, of FIGS. 1 and 2, respectively) may provide a convenient single source of truth that offers an all-inclusive view of sales lead, patient health, sales lead, etc.

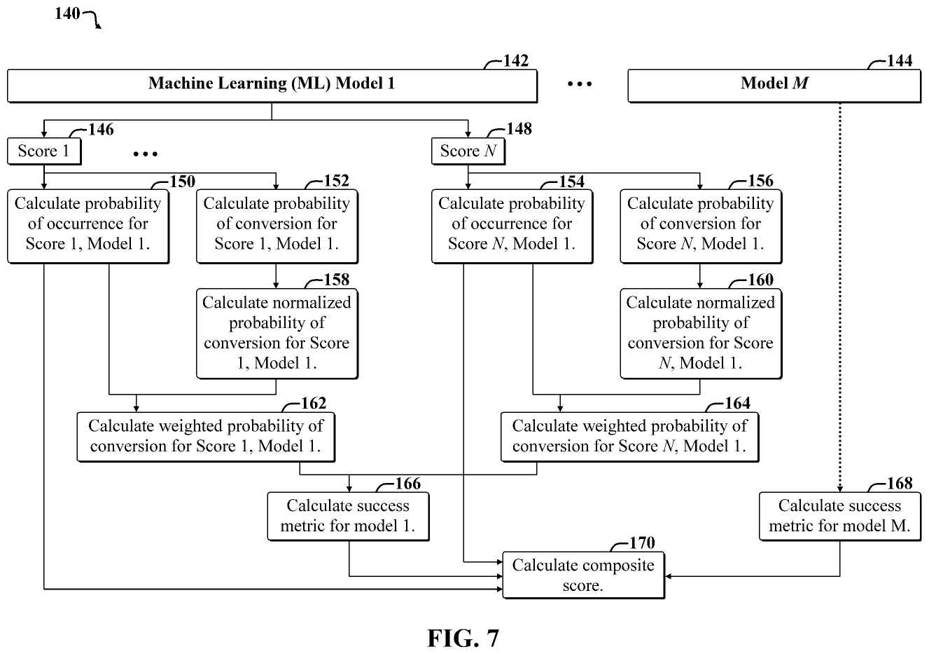

FIG. 7 is a flow diagram of a fifth example method 140, which graphically depicts calculation of a composite score based on one or more scores from one or more machine learning models, e.g., the machine learning models 44 of FIG. 2 and/or the machine learning models 14 of FIG. 1.

The fourth example method 140 may be implemented via the math model 26 of FIGS. 1 and 2. In the present example embodiment, the method illustrates M machine learning models 142-144, including a first machine learning module 142 and an Nth machine learning model 144.

The method 140 includes using the machine learning models 142-144 to generate one or more scores. For illustrative purposes, the first machine learning module 142 produces N scores, including a first score 146 and a Nth score 148.

Each score 246-148 is then used to calculate probabilities. For instance, a first probability-of-occurrence step 150 includes using the first score 146 to calculate a probability of occurrence for the occurrence of the first score being output by the first model 142 within a predetermined time interval. The probability of occurrence may be calculated by dividing the number of leads with a given score by the total number of leads output by the first math model 142, or otherwise, within a given working sample of scores provided by the first math model 142.

The first score 146 is also input to a probability-of-conversion step 152. The probability-of-conversion step 152 includes calculating a probability of conversion by dividing the number of leads with the first score that converted into an opportunity (historically) by the total number of leads output by the first model 142 exhibiting the same score (or a score within a predetermined threshold of the same score).

The results of the first probability-of-occurrence step 150 are provided as input to a composite score step/module 170.

The results of the probability-of-conversion step 152 are input to a normalized-probability step 158. The normalized probability step 158 calculates a normalized probability of conversion based on dividing the probability of conversion for a given score (as output by the probability-of-conversion step 152) by a sum of probabilities of conversion for the first machine learning model 142.

Both outputs from the probability-of-occurrence step 150 and outputs from the probability-of-conversion step 152 step are input to a weighted-probability-calculation step 162.

The weighted-probability-calculation step 162 involves multiplying the normalized probability of conversion (as output by step 158) by the probability of occurrence (as output by step 150), to thereby yield, as output, a weighted probability of conversion of the first score 146 for the first machine learning module 142.

The resulting weighted probability of conversion, output by step 162, is then input to a success-metric calculation step 166. The success-metric calculation step 166 involves calculation of a success metric, which herein is defined as the sum of the weighted probabilities of conversion (as output by the weighted-probability-calculation step 162) for each score in a given model, e.g., the first machine learning model 142.

Output from the weighted-probability-calculation step 162 is then input to a success metric step 166. The success metric step 166 involves adding up all of the weighted probabilities of conversion for each score in a given model, i.e., in this case, the first machine learning model 142. Results of the success metric step 166, representing success metric values, are then input to the composite score step/module 170.

Similarly, all of the scores output by the first machine learning module 142 are processed similarly. For instance a score N 148 is also processed by an Nth probability-of-occurrence step 154; an Nth probability of conversion step 156, an Nth normalized probability of conversion step 160, and an Nth weighted probability of conversion step 164, so as to provide input to the success-metric step 166, the output of which is provided to the composite score step/module 170.

Note that all machine learning models involved, including an Mth machine learning model 144, provide success metrics to the composite score step/module 170. In the case of output from the Mth machine learning model 144, an Mth success metric module 168 calculates the success metric for the machine learning model M 144. The resulting success metric is then also input into the composite score step/module 170.

The composite score step/module 170 then uses success metric inputs (e.g., from steps/modules 166-168), in combination with probability of occurrence data (e.g., as output via modules 152, 154, etc.), to calculate a composite score based on outputs (e.g., scores) from the machine learning modules 142-144.

The resulting composite score (as output by the composite score step/module 170) may then be used by other software, e.g., the UIs 18, 60, of FIGS. 1 and 2, respectively, to facilitate enhancing situational awareness of sales personnel, account managers, etc., as to characteristics of prospective leads. The characteristics include estimates, as provided by composite scores output by step 170 of FIG. 1, of the likelihood or propensity of a given lead to follow through and make a purchase or a product and/or service (and/or to sign up to a given organization, plan, group, affiliation, etc.).

Accordingly, the present example embodiment felicitates prioritization of leads, and concomitant informed-decision making by marketing personnel, e.g., sales representatives, account managers, and so on.

The fourth example method 140 presets a so-called lead scoring algorithm that combines intelligence, e.g., customer's digital body language, searches, clicks, job postings, competitive technology foot print, etc. from external data sources.

Machine learning models (e.g., the machine learning models 44 of FIG. 2) can track footprints of leads, including their buying patterns, their engagement at events, their responses to emails; specific e-blasts, click-throughs of website links, forwards of links, documents, and so on—thereby using that data/knowledge to facilitate creating a composite score(s) indicating optimized estimates of a give lead's likelihood to make a purchase within a given time interval. The composite score(s) can be used in combination with other data (e.g., represented by the second data set 56 of FIG. 2) to provide a marketing analysis, sales representative, or other enterprise personnel with enhanced insight as to leads; thereby facilitating informed decision making by the enterprise personnel.

Note that the fourth example method 140 may represent use of a weighted probability distribution. However, use of other and/or additional methods are possible. For instance Monte Carlo simulations may also be employed to filter inputs into the math models 26 of FIGS. 1 and 2.

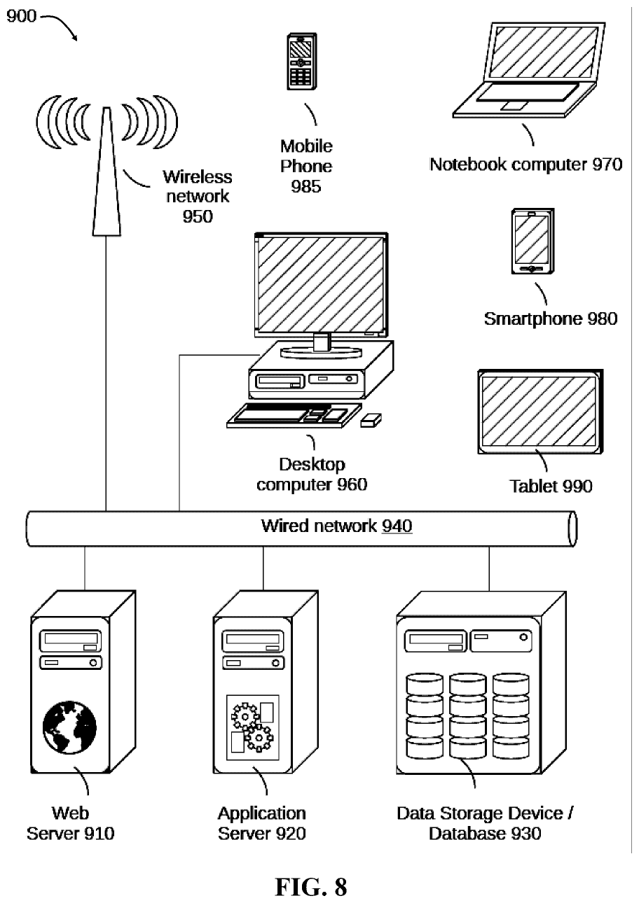

FIG. 8 is a general block diagram of a system 900 and accompanying computing environment usable to implement the embodiments of FIGS. 1-7. Embodiments may be implemented as standalone applications (for example, residing in a user device) or as web-based applications implemented using a combination of client-side and server-side code.

The general system 900 includes user devices 960-990, including desktop computers 960, notebook computers 970, smartphones 980, mobile phones 985, and tablets 990. The general system 900 can interface with any type of user device, such as a thin-client computer, Internet-enabled mobile telephone, mobile Internet access device, tablet, electronic book, or personal digital assistant, capable of displaying and navigating web pages or other types of electronic documents and UIs, and/or executing applications. Although the system 900 is shown with five user devices, any number of user devices can be supported.

A web server 910 is used to process requests from web browsers and standalone applications for web pages, electronic documents, enterprise data or other content, and other data from the user computers. The web server 910 may also provide push data or syndicated content, such as RSS feeds, of data related to enterprise operations.

An application server 920 operates one or more applications. The applications can be implemented as one or more scripts or programs written in any programming language, such as Java, C, C++, C#, or any scripting language, such as JavaScript or ECMAScript (European Computer Manufacturers Association Script), Perl, PHP (Hypertext Preprocessor), Python, Ruby, or TCL (Tool Command Language). Applications can be built using libraries or application frameworks, such as Rails, Enterprise JavaBeans, or .NET. Web content can created using HTML (HyperText Markup Language), CSS (Cascading Style Sheets), and other web technology, including templating languages and parsers.

The data applications running on the application server 920 are adapted to process input data and user computer requests and can store or retrieve data from data storage device or database 930. Database 930 stores data created and used by the data applications. In an embodiment, the database 930 includes a relational database that is adapted to store, update, and retrieve data in response to SQL format commands or other database query languages. Other embodiments may use unstructured data storage architectures and NoSQL (Not Only SQL) databases.

In an embodiment, the application server 920 includes one or more general-purpose computers capable of executing programs or scripts. In an embodiment, web server 910 is implemented as an application running on the one or more general-purpose computers. The web server 910 and application server 920 may be combined and executed on the same computers.

An electronic communication network 940-950 enables communication between user computing devices 960-990, web server 910, application server 920, and database 930. In an embodiment, networks 940-950 may further include any form of electrical or optical communication devices, including wired network 940 and wireless network 950. Networks 940-950 may also incorporate one or more local-area networks, such as an Ethernet network, wide-area networks, such as the Internet; cellular carrier data networks; and virtual networks, such as a virtual private network.

The system 900 is one example for executing applications according to an embodiment of the invention. In another embodiment, application server 920, web server 910, and optionally database 930 can be combined into a single server computer application and system. In a further embodiment, virtualization and virtual machine applications may be used to implement one or more of the application server 920, web server 910, and database 930.

In still further embodiments, all or a portion of the web and application serving functions may be integrated into an application running on each of the user computers. For example, a JavaScript application on the user computer may be used to retrieve or analyze data and display portions of the applications.

With reference to FIGS. 1 and 8, the account manager UI 18 may be implemented via a client computer, e.g., corresponding to one or more of the desktop computer 960, tablet 990, smartphone 980, notebook computer 970, and/or mobile phone 985 of FIG. 8.

The neural net trainer 12, machine learning models 14, composite lead score generator and classifier 16 of FIG. 1, may be implemented via the web server 910 and/or application server 920 of FIG. 8. Similarly, the marketing automation system 42, math model 26, and feedback loop adjuster 58 of FIG. 2 may be implemented via the web server 910 and/or application server 920 of FIG. 8. The databases 22 of FIGS. 1 and 52 of FIG. 2 may be implemented using the data storage device 930 of FIG. 8.

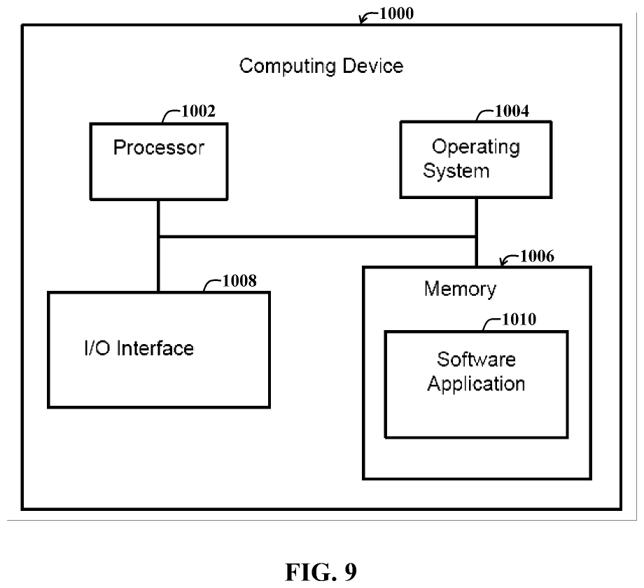

FIG. 9 illustrates a block diagram of an example computing device or system 500, which may be used for implementations described herein. For example, the computing device 1000 may be used to implement server devices 910, 920 of FIG. 8 as well as to perform the method implementations described herein. In some implementations, the computing device 1000 may include a processor 1002, an operating system 1004, a memory 1006, and an input/output (I/O) interface 1008.

In various implementations, the processor 1002 may be used to implement various functions and features described herein, as well as to perform the method implementations described herein. While the processor 1002 is described as performing implementations described herein, any suitable component or combination of components of the computing device 1000 or any suitable processor or processors associated with the device 1000 or any suitable system may perform the steps described. Implementations described herein may be carried out on a user device, on a server, or a combination of both.

The example computing device 1000 also includes a software application 1010, which may be stored on memory 1006 or on any other suitable storage location or computer-readable medium. The software application 1010 provides instructions that enable the processor 1002 to perform the functions described herein and other functions. The components of computing device 1000 may be implemented by one or more processors or any combination of hardware devices, as well as any combination of hardware, software, firmware, etc.

For ease of illustration, FIG. 9 shows one block for each of processor 1002, operating system 1004, memory 1006, I/O interface 1008, and software application 1010. These blocks 1002, 1004, 1006, 1008, and 1010 may represent multiple processors, operating systems, memories, I/O interfaces, and software applications. In various implementations, the computing device 1000 may not have all of the components shown and/or may have other elements including other types of components instead of, or in addition to, those shown herein.

Although the description has been described with respect to particular embodiments thereof, these particular embodiments are merely illustrative, and not restrictive. For instance, certain embodiments discussed herein may be used in the health care industry to facilitate informed health care decisions for patients.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments. For example, a non-transitory medium such as a hardware storage device can be used to store the control logic, which can include executable instructions.

Particular embodiments may be implemented by using a programmed general purpose digital computer, by using application specific integrated circuits, programmable logic devices, field programmable gate arrays, optical, chemical, biological, quantum or nanoengineered systems, etc. Other components and mechanisms may be used. In general, the functions of particular embodiments can be achieved by any means as is known in the art. Distributed, networked systems, components, and/or circuits can be used. Cloud computing or cloud services can be employed. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

A “processor” includes any suitable hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as random-access memory (RAM), read-only memory (ROM), magnetic or optical disk, or other non-transitory media suitable for storing instructions for execution by the processor.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

We claim:

1. A tangible processor-readable medium including instructions executable by one or more processors, and when executed operable for:
estimating a propensity for a business lead to purchase a product or service from an organization, including,
receiving output from two or more machine learning models, resulting in received output in response thereto, wherein the two or more machine learning models use different data sets to provide the output, wherein the output includes plural scores, including one or more scores from each of the two or more machine learning models; and
selectively combining the plural scores to provide a composite score via a combining method.

2. The tangible processor-readable medium of claim 1, further including:
selectively weighting and adding estimates using one or more weighted probability distributions.

3. The tangible processor-readable medium of claim 2, wherein the combining method further includes use of a Monty Carlo method.

4. The tangible processor-readable medium of claim 1, further including:
monitoring the composite score for accuracy to determine when the composite score becomes less accurate relative to its accuracy based on historical data; and
selectively adjusting the combining method so as to maintain or improve the accuracy of the composite score.

5. The tangible processor-readable medium of claim 1, further including:
providing the composite score to an analytics User Interface (UI), thereby facilitating informed decision making of a user of the UI.

6. The tangible processor-readable medium of claim 1, wherein each machine learning model receives plural database inputs describing or characterizing a business lead.

7. The tangible processor-readable medium of claim 6, wherein the database inputs may include one or more of the following:
website views associated with the lead, measurements of website click-through behaviors, data from email responses pertaining to the product or service, data with chats from sales representatives, and measurements of engagement at one or more events.

8. The tangible processor-readable medium of claim 7, wherein each machine learning model employs an artificial intelligence algorithm implemented via one or more trained neural networks, so as to output the one or more scores.

9. The tangible processor-readable medium of claim 7, further including:
selectively weighting one or more scores or metrics output by one or more machine learning models, so as to facilitate generating a composite score.

10. The tangible processor-readable medium of claim 9, further including:
using the composite score in an analytics User Interface (UI).

11. A method to facilitate estimating a propensity for a business lead to purchase a product or service from an organization, the method comprising:
receiving output from two or more machine learning models, resulting in received output in response thereto, wherein the two or more machine learning models use different data sets to provide the output, wherein the output includes plural scores, including one or more scores from each of the two or more machine learning models; and
selectively combining the plural scores to provide a composite score via a combining method.

12. The method of claim 11, wherein selectively combining further includes:
selectively weighting and adding estimates using one or more weighted probability distributions.

13. The method of claim 12, wherein selectively combining further includes use of a Monty Carlo method.

14. The method of claim 11, further including:
monitoring the composite score for accuracy to determine when the composite score becomes less accurate relative to its accuracy based on historical data; and
selectively adjusting the combining method so as to maintain or improve the accuracy of the composite score.

15. The method of claim 11, further including:
providing the composite score to an analytics User Interface (UI), thereby facilitating informed decision making of a user of the UI.

16. The method of claim 11, wherein each machine learning model receives plural database inputs describing or characterizing a business lead.

17. The method of claim 16, wherein the database inputs may include one or more of the following:
website views associated with the lead, measurements of website click-through behaviors, data from email responses pertaining to the product or service, data with chats from sales representatives, and measurements of engagement at one or more events.

18. The method of claim 17, wherein each machine learning model employs an artificial intelligence algorithm implemented via one or more trained neural networks, so as to output the one or more scores.

19. The method of claim 17, further including:
selectively weighting one or more scores or metrics output by one or more machine learning models, so as to facilitate generating a composite score; and
further including using the composite score in an analytics User Interface (UI).

20. An apparatus comprising:
one or more processors; and
logic encoded in one or more tangible media for execution by the one or more processors and when executed operable for:
estimating a propensity for a business lead to purchase a product or service from an organization, including,
receiving output from two or more machine learning models, resulting in received output in response thereto, wherein the two or more machine learning models use different data sets to provide the output, wherein the output includes plural scores, including one or more scores from each of the two or more machine learning models; and
selectively combining the plural scores to provide a composite score via a combining method.
